(19) United States
(12) Patent Application Publication
(10) Pub. No.: US 2007/0076073 A1
(43) Pub. Date: Apr. 5, 2007

(54) Inkjet inks and ink sets

(76) Inventor: John C. Hornby, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/540,700

(22) Filed: Sep. 29, 2006

Related U.S. Application Data
(60) Provisional application No. 60/723,116, filed on Oct. 3, 2005.

(51) Int. Cl. G01D 11/00; C09D 11/02; C09D 11/00

(52) U.S. Cl. 347/100; 106/31.58

(57) ABSTRACT

The present invention pertains to an aqueous inkjet ink containing an anionic dye as colorant, and a certain diol that has low water solubility. The present invention further pertains to an ink set containing this aqueous inkjet ink, as well as to methods of printing with this ink and ink set on a variety of substrates, and particularly textiles.

### CROSS-REFERENCE TO RELATED APPLICATION

This application claims priority under 35 U.S.C. §119 from U.S. Provisional Application Ser. No. 60/723,116, filed Oct. 3, 2005.

### BACKGROUND OF THE INVENTION

The present invention pertains to an aqueous inkjet ink containing an anionic dye as colorant, and a certain diol that has low water solubility. The present invention further pertains to an ink set containing this aqueous inkjet ink, as well as to methods of printing with this ink and ink set on a variety of substrates, and particularly textiles.

Digital printing methods such as inkjet printing are becoming increasingly important for the printing of textiles and offer a number of potential benefits over conventional printing methods such as screen printing. Digital printing eliminates the set up expense associated with screen preparation and can potentially enable cost effective short run production. Inkjet printing furthermore allows visual effects, like infinite pattern repeat sizes, that cannot be practically achieved with a screen printing process.

Both dyes and pigments have been used as colorants for such ink jet ink formulations. When dyes are used in ink jet inks (usually in the form of dye solutions), they rarely exceed concentrations of 4 wt % total dye solids based on the total weight of the ink. In the case of water-based ink jet inks intended for textile applications, it is often desirable to increase the concentration of the dye solids to above this 4 wt % barrier in order to obtain a deeply colored print on fabrics. At these higher level dye concentration levels, however, it has proven a challenge to incorporate large amounts of dye while maintaining good ink jetting properties and useful ink shelf life. In particular, the use of inks with high dye loadings leads to nozzle blockage and other jetting problems, as well as relatively low/short shelf life, as a result of particulate buildup/precipitate in the ink. Ideally, these inks should have shelf lives of at least 9 months for the ink product to be commercially practical.

Diols have been used as ink additives to accomplish various desirable results. For example, U.S. Pat. No. 6,818,048, U.S. Pat. No. 6,808,556, U.S. Pat. No. 6,398,357, U.S. Pat. No. 5,788,754 and U.S. Pat. No. 5,364,461 all describe uses of 1,2-alkyl diols. U.S. Pat. No. 6,538,049 describes the use of 2-8 carbon terminal alkanediols in an ink with a dispersed pigment. U.S. Pat. No. 6,187,086 describes the use of diols in an ink with a self-dispersed pigment to reduce bleed to dye-based CMY inks. U.S. Pat. No. 5,141,556 and U.S. Pat. No. 5,169,438 describe ink jet inks with aliphatic diols with a water solubility of at least 4.5 weight percent at 25° C.

All of the identified publications are incorporated by reference herein for all purposes as if fully set forth.

It is an object of this invention to provide an inkjet ink which has superior shelf life and permits adequate loading of anionic dyes in the ink, especially for textile printing.

### SUMMARY OF THE INVENTION

In accordance with one aspect of the present invention, there is provided an inkjet ink comprising an aqueous vehicle, an anionic dye colorant substantially soluble in the aqueous vehicle, and from about 0.5 wt % to about 18 wt %, based on the total weight of the ink, of a diol having from 7 to 9 carbon atoms, where the hydroxyls of the diol are not together at a 1,2-position on the diol, and wherein the diol has a solubility in water of less than about 4.25 wt % at 25° C.

In another aspect, the present invention pertains to an inkjet ink set comprising at least three differently colored inks, at least one of which is the ink is as set forth above and as described in more detail below. In one preferred embodiment, the ink set comprises at least three differently colored inks, one of which is a yellow ink, one of which is a magenta ink, and another of which is a cyan ink.

In yet another aspect, the present invention pertains to a method for ink jet printing, comprising the steps of:

(a) providing an ink jet printer that is responsive to digital data signals;

(b) loading the printer with a substrate to be printed;

(c) loading the printer with an inkjet ink or inkjet ink set as set forth above and as described in further detail below; and

(d) printing a print onto the substrate using the inkjet ink or inkjet ink set in response to the digital data signals.

A preferred substrate for the ink set is a textile substrate, more preferably a silk, nylon, nylon/Lycra® blend or wool substrate.

In still another aspect, the present invention pertains to silk, nylon and silk/Lycra® fabric article printed according the above inkjet printing method.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

Aqueous Vehicle

The vehicle is a carrier for the colorant. An “aqueous vehicle” refers to a vehicle comprised of water or a mixture of water and at least one water-soluble organic solvent (co-solvent). Selection of a suitable mixture depends on requirements of the specific application, such as desired surface tension and viscosity, the selected colorant, and compatibility with substrate onto which the ink will be printed.

Examples of water-soluble organic solvents include alcohols, ketones, keto-alcohols, ethers and others, such as thiodiglycol, sulfolane, 2-pyrrolidone, alkyl-pyrrolidones, 1,3-dimethyl-2-imidazolidinone, and caprolactam; glycols such as ethylene glycol, diethylene glycol, triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether.

An aqueous vehicle will typically contain about 30 wt % to about 95 wt % (based on the weight of the aqueous vehicle) water with the balance (i.e., about 70 wt % to about 5 wt %) being the water-soluble solvent.

Anionic Dye

The anionic dyes suitable for this invention include acid, reactive and direct dyes. Suitable acid dyes include, for example, the dyes described under “Acid Dyes” in the Colour Index, 3rd edition (3rd revision 1987, inclusive of Additions and Amendments up to No. 85). The anionic dyes that can be used may belong to a wide variety of dye classes and may, for example, contain one or more sulfonic acid groups. Examples of suitable classes of dyes include, but are not limited to, diphenylmethane, triarylmethane, xanthene, nitro, nitroso, stilbene and phthalocyanine dyes, having at least two sulfonic acid groups; heavy-metal-free monoazo and disazo dyes each having one or more sulfonic acid groups; heavy-metal-containing, namely copper-, chromium-, nickel- or cobalt-containing, monoazo, disazo, azomethine and formazan dyes, especially metallized dyes, that contain two molecules of azo dye, or one molecule of azo dye and one molecule of azomethine dye, bonded to a metal atom, especially such dyes containing mono-and/or dis-azo dyes and/or azomethine dyes as ligands and a chromium or cobalt ion as central atom; and anthraquinone dyes, especially 1-amino-4-arylaminoanthraquinone-2-sulfonic acids and 1,4-diarylamino- or 1-cycloalkylamino-4-arylaminoanthraquinonesulfonic acids.

The counterion for the anionic dyes can be sodium, potassium and other suitable counterion.

Low-Water-Soluble Diol

In addition to the aqueous vehicle and anionic dye, the inks in accordance with the present invention comprise from about 0.5 wt % to about 18 wt % (based on the total weight of the ink) of a 7 to 9 carbon diol wherein the hydroxyls of the diol together are not at a 1,2 position on the diol, and wherein the diol has a solubility in water of less than about 4.25 wt % at 25° C. The low-water-soluble diol may be straight-chained, branched or cyclic.

Examples of suitable low-water-soluble diols include 2-butyl-2-ethyl-1,3-propanediol (BEPD); 2,4-diethyl-1,5-pentanediol (PD-9); 1,8-octanediol; (cis)1,2-cyclohexanedimethanol; and 2-ethyl-1,3-hexanediol (EHD).

A preferred low-water-soluble diol is where at least one of the hydroxyl groups is a substituent on a secondary or tertiary carbon. Examples of such low-water-soluble diols include BEPD, PD-9 and EHD.

Also preferred is low-water-soluble diol that has a solubility in water of greater than about 0.5 wt % to less than about 3.5 wt % at 25° C.

A preferred low-water-soluble diol concentration in the ink is from about 1 wt % to about 10 wt % based on the total weight of the ink.

In addition to the low-water-soluble diol, the ink preferably comprises at least one diol with 6-9 carbon atoms and that has a water solubility of greater than about 4.25 wt % at 25° C. Examples of such diols include 2,2-diethyl-1,3-propanediol; 2-methyl-2-propyl-1,3-propanediol (MPPD); 1,4-cyclohexanedimethanol (CHDM); 2,5-dimethyl-2,5-hexanediol; and 2,5-dimethyl-2,4-pentanediol. These diols are preferably used in amounts up to about 25 wt % based on the total weight of the ink.

Additives

Other ingredients (additives) may be formulated into the inkjet ink, to the extent that such other ingredients do not interfere with the stability and jetablity of the finished ink, which may be readily determined by routine experimentation. Such other ingredients are in a general sense well known in the art.

Commonly, surfactants are added to the ink to adjust surface tension and wetting properties. Suitable surfactants include ethoxylated acetylene diols (e.g. Surfynols® series from Air Products), ethoxylated primary (e.g. Tomadol® series from Tomah Products) and secondary (e.g. Tergitol® series from Union Carbide) alcohols, sulfosuccinates (e.g. Aerosol® series from Cytec), organosilicones (e.g. Silwet® series from GE Silicons) and fluoro surfactants (e.g. Zonyl® series from DuPont). Surfactants are typically used in the amount of from about 0.01 wt % to about 5 wt %, and preferably from about 0.2 wt % to about 2 wt %, based on the total weight of the ink.

Polymers may be added to the ink to improve durability. The polymers can be soluble in the vehicle or dispersed (e.g. “emulsion polymer” or “latex”), and can be ionic or nonionic. Useful classes of polymers include acrylics, styrene-acrylics, polyurethanes and crosslinked polyurethanes. In addition, polymers may be added to modify the viscosity. Examples include polyethylene glycol, polypropylene glycol, and poly vinylpyrrolidone,

Biocides may be used to inhibit growth of microorganisms. Buffers may be used to maintain pH. Buffers include, for example, tris(hydroxymethyl)-aminomethane (“Trizma” or “Tris”).

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Proportions of Ingredients

The components described above can be combined to make an ink in various proportions and combinations in order to achieve desired ink properties, as generally described above, and as generally recognized by those of ordinary skill in the art. Some experimentation may be necessary to optimize inks for a particular end use, but such optimization is generally within the ordinary skill in the art.

The amount of vehicle in an ink is typically in the range of from about 70 wt % to about 99.4 wt %, and more typically from about 80 wt % to about 99 wt %. The anionic dyes are generally present in amounts up to about 15 wt %, more typically from about 0.5 wt % to about 12 wt %, and preferably from about 3 wt % to about 10 wt %. As indicated previously, suitable inks can be made with concentrations of at least about 4wt %, and preferably from about 4 wt % to about 10 wt %. Percentages are weight percent of the total weight of ink.

Other ingredients (additives), when present, generally comprise less than about 15 wt %, based on the total weight of the ink. Surfactants, when added, are generally in the range of from about 0.2 wt % to about 3 wt %, based on the total weight of the ink. Polymers can be added as needed, but will generally be less than about 15 wt %, based on the total weight of the ink.

Ink Properties

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as 30 cP at 25° C., but is typically somewhat lower. The ink has physical properties are adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic.

Ink Set

The term “ink set” refers to all the individual inks or other fluids an inkjet printer is equipped to jet.

The ink sets in accordance with the present invention preferably comprise at least three differently colored inks (such as CMY), or at least four differently colored inks (such as CMYK), wherein at least one of the inks is an aqueous inkjet ink as described above.

The other inks of the ink set are preferably also aqueous inks, and may contain dyes, pigments or combinations thereof as the colorant. Such other inks are, in a general sense, well known to those of ordinary skill in the art.

Preferably all of the inks in the inkjet ink set are inkjet inks in accordance with the present invention as described above.

In addition to one or more of the typical CMYK colors, the ink sets in accordance with the present invention may further comprise one or more “gamut-expanding” inks, including different colored inks such as an orange ink, a green ink, a violet ink, a red ink and/or a blue ink, and combinations of full strength and light strengths inks such as light cyan and light magenta.

Substrate

The instant ink and the ink set containing the instant ink is especially advantageous for printing substrate that is silk, nylon, nylon/Lycra® and wool.

The fabric is commonly pretreated prior to printing. Application of the pretreatment to the fabric can be any convenient method and such methods are generally well-known in the art. One example is an application method referred to as padding. In padding, a fabric is dipped in the pretreatment solution, then the saturated fabric is passed through nip rollers that squeeze out the excess solution. The amount of solution retained in the fabric can be regulated by the nip pressure applied by the rollers. Other pretreatment techniques include spray application wherein the solution is applied by spraying on the face or face and back of the fabric. The wet pick-up of pretreatment solution is preferably from about 20 and about 100 grams of solution, and more preferably from about 25 to about 75 grams of solution, per 100 grams of fabric.

After application of pretreatment the fabric is dried in any convenient manner. The final percent moisture is (approximately) equal to the equilibrium moisture of the pretreated fabric at ambient temperature, and can vary somewhat depending on the relative humidity of the surrounding air.

The resins remaining in the fabric after drying provide the absorbent layer for the inkjet inks during printing. It will be appreciated that sufficient resin must be present to absorb the ink load applied. On the other hand, the presence of too much resin may prevent proper penetration. Routine optimization will reveal appropriate coating levels for a given printer and ink set.

Suitable pretreatments include those disclosed in U.S. application Ser. No. 11/070711 (filed Mar. 2, 2005), as well as those disclosed in U.S. Pat. No. 6,656,228 and US20020081421, the disclosures of which are incorporated by reference herein for all purposes as if fully set forth.

Printing Method

Printing can be accomplished by any inkjet printer equipped for handling and printing fabric. Commercial printers include, for example, the Dupont™ Artistri™ 3210 and 2020 printers, and the Mimaki TX series of printers.

The amount of ink laid down on the fabric can vary by printer model, by print mode (resolution) within a given printer and by the percent coverage need to achieve a given color. The combined effect of all these considerations is grams of ink per unit area of fabric for each color. In one embodiment, ink coverage is preferably from about 5 to about 17 grams of ink per square meter of fabric. There is a balance between the ink density needed to achieve a desired color and the absorption capacity of the coating resins in the pretreatment.

Printed fabric will typically be post-treated according to procedures well-known in the textile art. A preferred post treatment is to heat the printed fabric with steam-treatment to set the printed inks, and washing the steam-treated fabric. After treatments may also be employed after washing to enhance end-use properties, such as wash fastness.

### EXAMPLES

Solubility of Acid Dye

The solubility of Acid Red 131 in water was tested with various diols at ambient temperature. 1.0 grams of AR131, 0.5 grams of a diol and 8.5 grams of deionized water were added to a 20 ml vial. The vial was sealed and rolled for 18 hours. The contents of the vial were put into a 60 cc syringe with a filter disc (Whatman Puradisc 25 mm GF/F (0.7 microns)) attached to the end and the fluid was pushed through the filter into another clean vial. The solution was diluted by a factor of 10,000 by successive dilutions. The UV absorbance was measured with a Alident/HP 8453 diode array spectrophotometer, and the dye concentration was calculated from the measured values. The results of the test using several different diols is given in Table 1. For comparison, AR131 has a solubility in deionized water of 1.1 wt % at 25° C. when prepared in the same manner without any diol.

TABLE 1
Solubility of AR131 in Water with Various Diols

| | % Dye Solubilized |
|---|---|
| Low-Water-Soluble Diols | |
| 2-Butyl-2-ethyl-1,3-propanediol (BEPD) | 9.7 |
| 2,4-Diethyl-1,5-pentanediol | 8.3 |
| 2-Ethyl-1,3-hexanediol (EHD) | 6.9 |
| 1,8-Octanediol | 9.5 |
| Cis-1,2-Cyclohexanedimethanol | 7.4 |
| Comparative Diols of 7 and 8 Carbon Chain Lengths | |
| 1,2-Octanediol | 8.4 |
| 2,2-Diethyl-1,3-Propanediol | 7.6 |
| 2-Methyl-2-Propyl-1,3-Propanediol (MPPD) | 7.3 |
| 2,5-Dimethyl-2,5-Hexanediol | 2.7 |
| 1,4-Cyclohexanedimethanol (CHDM) | 6.0 |
| Comparative Diols of Other Carbon Chain Length | |
| 1,2-Hexanediol | 7.7 |
| 1,6-Hexanediol | 4.1 |
| 2,3-Dimethyl-2,3-butanediol | 2.3 |
| 2,2-Dimethyl-1,3-propanediol | 2.1 |
| 1,10-Decanediol | 2.0 |
| 1,2-Butanediol | 1.9 |
| 1,3-Propanediol | 1.3 |
| 1,2-Propanediol | 1.3 |
| Ethylene glycol | 1.2 |

Other dyes were tested in a similar manner. These dyes were Acid Red 249, Acid Red 274 and Acid Blue 290. The results of solubility tests are shown in Table II.

TABLE 2

| | AR 249 | AR 74 | AB290 |
|---|---|---|---|
| Low-Water-Soluble Diols | | | |
| 2-Butyl-2-ethyl-1,3-propanediol | 9.64 | 7.92 | 5.50 |
| 2,4-diethyl-1,5-pentanediol | 9.77 | 7.98 | ND |
| Comparison Diols | | | |
| 1,6-Hexanediol | 8.20 | 4.55 | ND |
| 2-Methyl-2-propyl-1,3-propanediol | 9.47 | 7.03 | 4.85 |
| 2,2-Diethyl-1,3-propanediol | 9.06 | 7.96 | ND |
| water, for further comparison | 1.67 | 0.14 | 4.71 |

ND = not determined

Solubility of Diols in Water

The solubility of various diols in water was measured by weighing diol and water into a 20 ml vial, rolling the vial for 24 hours, and observing whether or not one phase was present. The vials were then rolled for an additional 24 hours, and observed again for the presence of phases. The results are reported in Table 3.

TABLE 3

| | | | % Concentration in Water | | | | | |
|---|---|---|---|---|---|---|---|---|
| | | Diol Name | 0.5 | 1.0 | 2.0 | 3.0 | 4.0 | 4.5 |
| Inv. | C₈ | (cis)1,2- | S | S | S | S* | I | I |
| | | Cyclohexane- | | | | | | |
| | | dimethanol | | | | | | |
| Inv. | C₈ | 2-Ethyl-1,3- | S | S | S | I | I | I |
| | | Hexanediol | | | | | | |
| Inv. | C₈ | 1,8-Octanediol | S | S* | I | I | I | I |
| Inv. | C₉ | 2,4-Diethyl-1,5- | S | S | I | I | I | I |
| | | Pentanediol (PD-9) | | | | | | |
| Inv. | C₉ | 2-Butyl-2-Ethyl- | S | I | I | I | I | I |
| | | 1,3-Propanediol | | | | | | |
| | | (BEPD) | | | | | | |
| Comp. | C₇ | 2,2-Diethyl-1,3- | S | S | S | S | S | S |
| | | Propanediol | | | | | | |
| Comp. | C₇ | 2-Methyl-2-Propyl- | S | S | S | S | S | S |
| | | 1,3-Propanediol | | | | | | |
| | | (MPPD) | | | | | | |
| Comp. | C₈ | 1,4- | S | S | S | S | S | S |
| | | Cyclohexane- | | | | | | |
| | | dimethanol (CHDM) | | | | | | |
| Comp. | C₈ | 2,5-Dimethyl-2,5- | S | S | S | S | S | S |
| | | Hexanediol | | | | | | |
| Comp. | C₈ | 1,2-Octanediol | I | I | I | I | I | I |
| Comp. | C₁₀ | 1,2-Decanediol | I | I | I | I | I | I |
| Comp. | C₁₀ | 1,10-Decanediol | I | I | I | I | I | I |

Notes:
S, soluble;
I insoluble;
*sample was cloudy;

Some solubility data was available from the Industrial Solvent Handbook, E. W. Flock, 3^{rd} Edition:

2-ethyl-1,3-hexanediol, 4.2% (inventive);

1,2,4-trimethyl-1,3-pentanediol, 1.9% (inventive) (reported at 25° C.); and

2,2-diethyl-1,3-propanediol, 25% (comparative).

The above percentages are wt % at 20° C., as reported in previously incorporated U.S. Pat. No. 5,141,556.

Preparation of Inks

Inks were prepared according to the formulations in the following tables wherein amounts are ink weight percent of the total weight of ink. Ingredients were mixed together and filtered. Water was deionized. Colorants were “inkjet grade” meaning that they were relatively pure and free of excessive amounts of salts. Surfynol® 440 is a surfactant from Air Products Corp (Allentown, Pa., USA). Proxel™ GXL is a Biocide from Avecia (Wilmington, Del., USA). Trizma is tris(hydroxymethyl)aminomethane. PEG 4600 is polyethylene glycol (4400 to 4800 average molecular weight). If necessary, the pH was adjusted to the desired level (about 8.5 to about 9.5 for acid dyes) with nitric acid or potassium hydroxide.

Preparation of Anionic Dye Ink with Low-Water-Soluble Diol

Three inks were prepared with three different levels of the low-water-soluble diol 2-butyl-2-ethyl-1,3-propanediol (BEPD). The inks were tested in accelerating aging tests and printing tests. The AR131 was obtained from Oriental Giant Dyes & Chemical Ind. Corp. (Taiwan), and further purified by using nanofiltration and ultrafiltration membranes. The dye was desalted, filtered and concentrated to a concentrate (about 10-11 wt % in water and residual processing solvent) to be made into ink. Table 4 shows the ink compositions, and Table 5 shows the key properties of the ink after accelerated aging conditions. One of these conditions was a seven-day storage test at 70° C., and the other condition was a seven-day storage test at −25° C.

TABLE 4
Ink Combinations with Low Water Soluble Diol

| Component | Ink 1 | Ink 2 | Ink 3 |
|---|---|---|---|
| AR-131 | 4.00% | 4.00% | 4.00% |
| 2-Pyrrolidone | 20.00% | 20.00% | 20.00% |
| BEPD | 2.00% | 4.00% | 6.00% |
| Ethylene glycol | 29.50% | 30.00% | 26.30% |
| Glycerol | 12.00% | 12.00% | 12.00% |
| PEG 4600 | 0.50% | — | — |
| Proxel ™ GXL | 0.20% | 0.20% | 0.20% |
| Trizma solution | 1.20% | 1.20% | 1.20% |
| Water | Bal. to 100% | Bal. to 100% | Bal. to 100% |

TABLE 5
Ink Properties

| | Initial Ink Properties | | |
|---|---|---|---|
| | Ink 1 | Ink 2 | Ink 3 |
| Initial pH | 7.57 | 7.66 | 7.59 |
| Adjusted pH | 8.49 | 8.54 | 8.51 |
| Surface Tension | 38.9 | 35.6 | 33.5 |
| Viscosity (60 | 8.99 | 9.20 | 9.05 |
| rpm@25° C.) cps | | | |
| Microscope | fines and small | fines and small | fines and small |
| Observations | particles- | particles- | particles- |
| | low concentration, | low concentration, | low concentration, |
| | no crystals | no crystals | no crystals |
| | Oven - After 7 days @ 70° C. | | |
| PH | 8.66 | 8.64 | 8.60 |
| Viscosity (60 | 8.74 | 9.12 | 8.96 |
| rpm@25° C.) cps | | | |
| Microscope | small particles- | small particles- | small particles- |
| Observations | low concentration, | low concentration, | low concentration, |
| | no crystals | no crystals | no crystals |
| | Freezer - After 7 days @ −25° C. | | |
| PH | 8.89 | 8.84 | 8.80 |
| Viscosity (60 | 8.64 | 9.08 | 8.95 |
| rpm@25° C.) cps | | | |
| Microscope | small particles- | small particles- | small particles- |
| Observations | low concentration, | low concentration, | low concentration, |
| | no crystals | no crystals | no crystals |

Five inks were prepared and tested with combinations of low-water-soluble diols and a high-water-soluble diol in an identical manner to Inks 1-3. The ink compositions are provided in Table 6, and the results are listed in Table 7.

TABLE 6
Ink Combinations with Low Water Soluble
Diols and High Water Soluble Diols

| Component | Ink 4 | Ink 5 | Ink 6 | Ink 7 | Ink 8 |
|---|---|---|---|---|---|
| AR-131 | 5.00% | 5.00% | 5.00% | 5.00% | 5.00% |
| 2-Pyrrolidone | 20.00% | 20.00% | 20.00% | 20.00% | 20.00% |
| MPPD | | | 15.00% | 15.00% | 15.00% |
| BEPD | 2.00% | 3.00% | 1.00% | 2.00% | 3.00% |
| CHDM | 15.00% | 15.00% | | | |
| 1,2-Hexanediol | | | | | |
| Glycerol | 11.75% | 10.25% | 13.25% | 12.25% | 11.25% |
| PEG 4600 | 0.50% | — | | | — |
| Proxel ™ GXL | 0.20% | 0.20% | 0.20% | 0.20% | 0.20% |
| Trizma | 0.20% | 0.20% | 0.20% | 0.20% | 10.20% |
| Water | Bal. to | Bal. to | Bal. to | Bal. to | Bal. to |
| | 100% | 100% | 100% | 100% | 100% |

TABLE 7
Ink Properties

| | Initial Ink Properties | | | | |
|---|---|---|---|---|---|
| | Ink 4 | Ink 5 | Ink 6 | Ink 7 | Ink 8 |
| Initial pH | 9.78 | 9.78 | 9.76 | 9.75 | 9.75 |
| Adjusted pH | 8.50 | 8.49 | 8.49 | 8.49 | 8.41 |
| Surface Tension | 39.7 | 38.4 | 34.3 | 33.6 | 33.3 |
| Viscosity (60 | 7.45 | 7.44 | 7.06 | 7.21 | 7.38 |
| rpm@25° C.), cps | | | | | |
| | Oven - After 7 days@70° C. | | | | |
| pH | 8.46 | 8.46 | 8.42 | 8.46 | 8.35 |
| Viscosity (60 | 7.42 | 7.43 | 7.23 | 7.29 | 7.41 |
| rpm@25° C.), cps | | | | | |
| Microscope | Clean | Clean | Clean | Clean | Clean |
| Observations | | | | | |
| | Freezer - After 7 days@−25° C. | | | | |
| pH | 8.57 | 8.57 | 8.54 | 8.55 | 8.47 |
| Viscosity (60 | 7.52 | 7.37 | 7.12 | 7.17 | 7.40 |
| rpm@25° C.) cps | | | | | |
| Microscope | Clean | Clean | Clean | Clean | Clean |
| Observations | | | | | |

Each of the inks 1-8 were printed on a Seiko IP-4010 printer with a piezo drop-on-demand print head, and exhibited no noticable/significant performance differences. No printhead priming issues were observed and jetting parameters such as drop velocity, nozzle out, misdirect and satellite levels, decap latency and sustainability were within a range to ensure high quality images. Initial testing was conducted using a paper substrate.

Similarly formulated inks were tested on a Dupont™ Artistri™ 2020 printer. Printing was done for at least seven days to assure long-term ink stability in the printer and consistently printed images on silk and/or nylon/Lycra®.

1. An inkjet ink comprising an aqueous vehicle, an anionic dye colorant substantially soluble in the aqueous vehicle, and from about 0.5 wt % to about 18 wt %, based on the total weight of the ink, of a diol having from 7 to 9 carbon atoms, where the hydroxyls of the diol are not together at a 1,2-position on the diol, and wherein the diol has a solubility in water of less than about 4.25 wt % at 25° C.

2. The inkjet ink of claim 1 where the low water soluble diol has at least one of the hydroxyl group substituted at a secondary or tertiary carbon.

3. The inkjet ink of any one or combination of the previous claims, wherein the diol has a solubility in water of greater than about 0.5 wt % to less than about 3.5 wt % at 25° C.

4. The inkjet ink of any one or combination of the previous claims, comprising from about 1 wt % to about 10 wt % of the diol.

5. The inkjet ink of any one or combination of the previous claims, comprising the anionic dye in an amount of up to about 15 wt %, based on the total weight of the ink.

6. The inkjet ink of any one or combination of the previous claims, having a surface tension in the range of about 20 mN/m to about 70 mN/m at 25° C., and a viscosity up to about 30 mPa.s at 25° C.

7. The inkjet ink of any one or combination of the previous claims, further comprising a second diol with 6-9 carbons and a water solubility greater than about 4.25 wt % at 25° C.

8. The inkjet ink of claim 7, wherein the second diol is present in an amount up to about 25 wt %, basedon the total weight of the ink.

9. An inkjet ink set comprising at least three differently colored inks, at least one of which is an ink as set forth in any one or combination of claims 1-8.

10. The inkjet ink set of claim 9, wherein the ink set comprises at least three differently colored inks, at least one of which is a yellow ink, at least one of which is a magenta ink, and at least one of which is a cyan ink.

11. The inkjet ink of claim 10, wherein a yellow ink, a magenta ink and a cyan ink each individually are inks as set forth in any one or combination of claims 1-8.

12. A method for ink jet printing, comprising the steps of:
(a) providing an ink jet printer that is responsive to digital data signals;
(b) loading the printer with a substrate to be printed;
(c) loading the printer with an inkjet ink as set forth in any one or combination of claims 1-8, or an inkjet ink set as set forth in any one or combination of claims 9-11; and
(d) printing a print onto the substrate using the inkjet ink or inkjet ink set in response to the digital data signals.

13. The method of claim 12, wherein the substrate is a textile substrate.

14. The method of claim 13, wherein the substrate is selected from the group consisting of a silk, a nylon, a nylon/Lycra® blend and a wool substrate.
